(19) United States
(12) Patent Application Publication
(10) Pub. No.: US 2010/0312926 A1
(43) Pub. Date: Dec. 9, 2010

(54) SWITCH FOR A TWO WAY CONNECTION BETWEEN A REMOVABLE CARD, A MOBILE WIRELESS COMMUNICATION DEVICE, OR A COMPUTER

(75) Inventors: Siamak Arya, Cupertino, CA (US); Fong-Long Lin, Fremont, CA (US); Thao Thach Tran, Fremont, CA (US)

Correspondence Address: DLA PIPER LLP (US ), 2000 UNIVERSITY AVENUE, EAST PALO ALTO, CA, 94303-2248, US

(73) Assignee: Silicon Storage Technology, Inc.

(21) Appl. No.: 12/477,799

(22) Filed: Jun. 3, 2009

(51) Int. Cl. G06F 3/00; H04B 7/005

(52) U.S. Cl. 710/51; 370/278

(57) ABSTRACT

A USB switching device can selectively connect between a removable card and a mobile wireless communication device and a computer. The removable card has a first port; the mobile wireless communicating device has a second port while the computer has a third port. The switching device comprises a first full duplex switch having an input and a first output and a second output, and a select port for switching the connection of the input to the first output and the connection of the input to the second output. The switching device further comprises a second full duplex switch having an input and a first output and a second output, and a select port for switching the connection of the input to the first output and the connection of the input to the second output. The switching device further comprises a third full duplex switch having an input and a first output and a second output, and a select port for switching the connection of the input to the first output and the connection of the input to the second output. The input of the first switch is connected to the first port. The input of the second switch is connected to the second port. The input of the third switch is connected to the third port. The first output of the first switch is connected to the second output of the second switch. The second output of the first switch is connected to the first output of the third switch. Finally, the first output of the second switch is connected to the second output of the third switch.

### TECHNICAL FIELD

The present invention relates to a switch for allowing a removable card to be accessed by a mobile wireless communication device or a computer in order to utilize its capabilities. It also alternatively allows the connection between the mobile wireless communication device and the computer. More particularly, the present invention relates to a switch for connecting to three USB devices and permitting two way communication between two of the three USB devices at a time.

### BACKGROUND OF THE INVENTION

Mobile wireless communication devices, such as cell phones are well known in the art Typically, a cell phone has a removable card (called “SIM card”) which consists of a computer with RAM, ROM or EEPROM or Flash memory, I/O pads, and security monitoring circuit all mounted on a removable card. The recent high capacity SIM cards use a USB interface. Most phones, currently, only have a single USB connection that is designed to connect to a PC directly or through a docking station. This connection is used for the PC to access the contents of the phone, and for the phone to be connected to the contents and facilities of the computer.

In order for the mobile device to connect to the removable card or the computer, it needs more than one connection. Thus, it is desirable for the mobile device to be able to connect to the removable card or to the computer. In addition, it is desired for the computer to be able to gain access to the removable card. Hence, a switching capability to connect any two of the mobile device, the removable card, and the computer is highly desirable.

### SUMMARY OF THE INVENTION

In the present invention, a switching device can selectively connect a removable card having a first port to a mobile wireless communicating device having a second port or to a computer having a third port. The switching device comprises a first full duplex switch having an input and a first output and a second output, and a select port for switching the connection of the input to the first output and the connection of the input to the second output. The switching device further comprises a second full duplex switch having an input and a first output and a second output, and a select port for switching the connection of the input to the first output and the connection of the input to the second output. The switching device further comprises a third full duplex switch having an input and a first output and a second output, and a select port for switching the connection of the input to the first output and the connection of the input to the second output. The input of the first switch is connected to the first port. The input of the second switch is connected to the second port. The input of the duplex switch is connected to the third port. The first output of the first switch is connected to the second output of the second switch. The second output of the first switch is connected to the first output of the third switch. Finally, the first output of the second switch is connected to the second output of the third switch.

### BRIEF DESCRIPTION OF THE DRAWINGS

FIG. 1 is a diagram of one example of a removable card connected to a mobile wireless communication device for connection to a mobile network, as well as to the Internet.

FIG. 2 is a schematic diagram of one example of the removable card connected to the mobile wireless communication device.

FIG. 3 is a block level diagram of one example of a removable card.

FIG. 4 is a detailed circuit diagram of one example of a processor portion in the removable card.

FIG. 5 is a diagram of the two modes of communication of the mobile wireless communication device with the removable card with the Internet, wherein in the first mode, the removable card communicates through the wireless communication device wirelessly with the mobile network for access to the Internet, and wherein in a second mode the removable card is connected to a network portal device for connection to the Internet.

FIG. 6 is a block diagram of one embodiment of the switch of the present invention for connecting the removable card to the mobile wireless device or to the computer for connection to the Internet, or connecting the mobile wireless device to the computer.

FIG. 7 is a block diagram of another embodiment of the switch of the present invention for connecting the removable card to the mobile wireless device or to the computer for connection to the Internet, or connecting the mobile wireless device to the computer.

### DETAILED DESCRIPTION OF THE PREFERRED EMBODIMENT

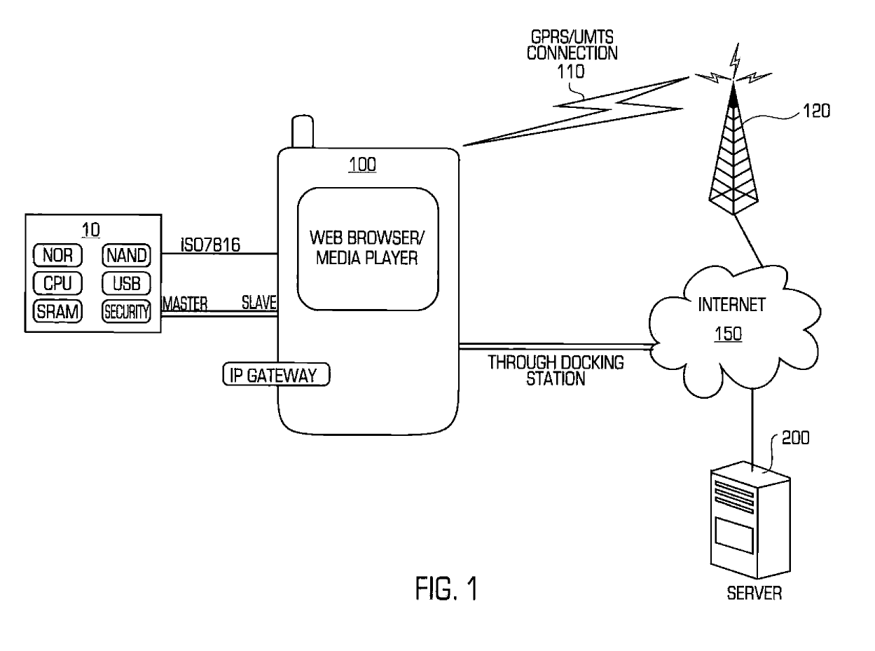

Referring to FIG. 1 there is shown a graphic illustration of a mobile wireless communication device 100, e.g. a cell phone 100 for use in a publicly accessible (common carrier) wireless communication network, such as a cellular network 110, which includes cellular access towers 120. The cellular network 110, through access servers (not shown) located on or near the cell phone towers 120 can connect to a network of interconnected computer networks 150, also known as the Internet 150. Thus, the cell phone 100 can communicate wirelessly with other cell phones 100 on the cell phone network 110. In addition, the cell phone 100 can communicate wirelessly with the Internet 150 through the cell phone network 110 which has the access servers connected to the Internet 150. Further, as will be shown hereinbelow, the removable card 10 portion of the cell phone 100 can also be connected directly to the Internet 150 through a network portal device, with a switching device 160 of the present invention, which is connected to a personal computer, which connects to the Internet 150. The cell phone 100 has a removable card 10, much like the removable SIM card of the prior art.

Referring to FIG. 2, there is shown a schematic diagram of on example of a removable card 10 that can be connected to the mobile wireless communication device 100. Because the device 100 is designed to operate wirelessly across the cellular network 110, the device 100 comprises an antenna 102. A transceiver 104 is connected to the antenna 102. The transceiver 104 transmits and receives modulated signals to and from the cellular network 110. Such components are well known in the art. The received signals may be demodulated and then converted into digital signals and provided to a gateway 106. The gateway 106 may also have an NAT (Network Address Translation) circuit. An NAT circuit 106 translates or maps a private IP address to one or more ports of a public IP address. As will be discussed hereinafter, the device 100 (through the removable card 10), may be assigned a public address (through the well known DHCP protocol) when the device is connected to the Internet 150, and may have a private address when operating as a local server such that the device 100 is not connected to the Internet 150. Digital signals to be transmitted are modulated and converted by the transceiver 104 into appropriate electromagnetic frequency signals for transmission by the antenna 102. Because the device 100 can access the Internet 150, a browser and media player 112 is also provided. The browser and media player 112 interfaces in the well known TCP/IP protocol as well as the HTTP protocol with the gateway 106 to provide and to receive digital signals received by the device 100 from the Internet 150, which may be displayed on a display 108. Associated with the browser and media player 112 is a processor (not shown) which also controls the transceiver 104 and other well known hardware circuits of the device 100 to communicate with the network 110.

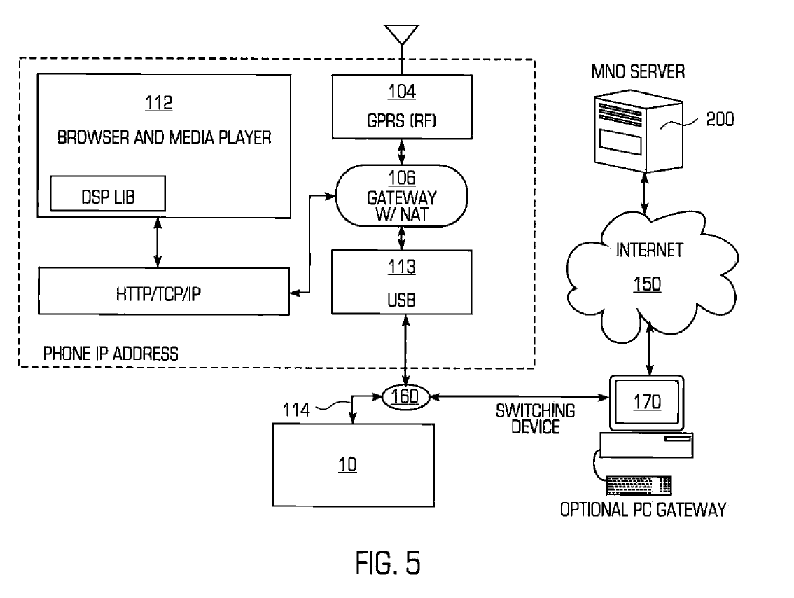

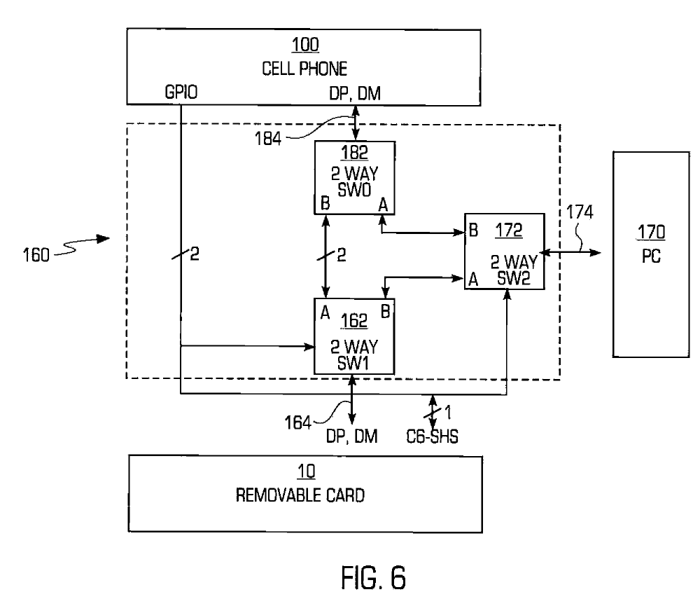

The one example of a removable card 10 is connected to the device 100 through a well known USB bus 114 to the switching device 160, as shown in FIG. 6. From the switching device 160, the USB interface 113 connects to the Gateway 106. Thus, digital signals from the removable card 10 are provided to and from the device 100 through the switching device 160, through the USB interface 113, through the gateway 106 and through the transceiver 104 to the antenna 102 (shown in FIG. 5).

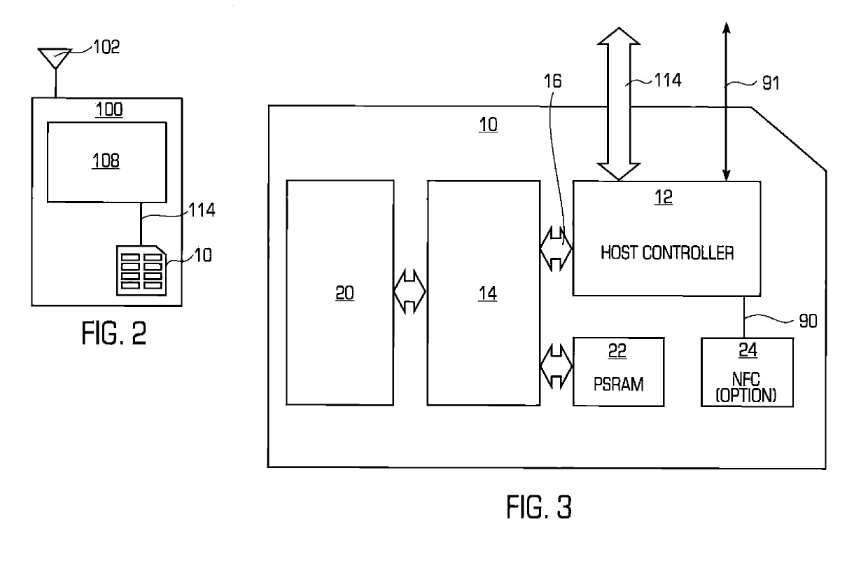

The one example of a removable card 10 is shown in greater detail in FIG. 3. In particular, the card 10 comprises a host controller 12 which interfaces with the USB bus 114. In addition, the host controller 12 is connected to a memory controller 14, through a bus 16. The memory controller 14 controls a NAND memory 20 and a PSRAM 22. The operation of the memory controller 14 in controlling the NAND memory 20 and the PSRAM 22 is fully described in U.S. patent application Ser. No. 11/637,420, published on Jun. 28, 2007 under publication 2007-0147115, and assigned to the present assignee, which disclosure is incorporated by reference herein in its entirety. The host controller 12 may also be optionally connected to a Near Field Communicator (NFC) 24. An NFC 24 is a close range RF circuit that permits wireless communication in close proximity. Thus, the device 100 with the NEC 24 may act as an “electronic wallet” for financial transactions or for identification purpose, or as another access to the Internet 150. Of course, the device 100 can also be connected wirelessly with the Internet 150 via other forms of wireless networks, such as a Wi-Fi network.

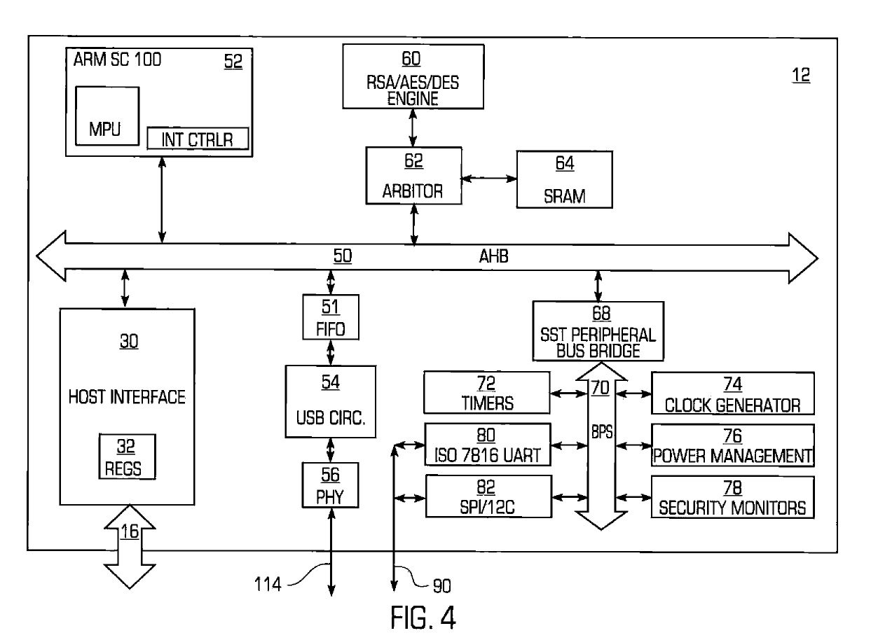

Referring to FIG. 4, there is shown a detailed schematic block diagram of the host controller 12. The host controller 12 comprises a high speed bus 50, to which a host interface 30, for connecting to the memory controller 14 is attached. The host interface 30 also comprises registers 32 for temporarily holding data that is supplied to and from the memory controller 14. The host controller 12 also comprises a FIFO (First-In First Out) circuit 51 which is connected to the high speed bus 50. The FIFO 51 is also connected to a USB controller circuit 54, which is connected to a PHY circuit 56 (which is the standard physical layer interface for a USB port. The circuit 56 includes pads, voltage level shifters and clock recovery circuits.) for connection to the USB bus 114. A secure processor, such as an ARM SC-100 processor 52 is also connected to the high speed bus 50.

The host controller 12 also comprises a RSA/AES/DES engine 60, which is a secure co-processor to the ARM SC-100 processor 52. The engine 60 is connected to the high speed bus 50 through an arbitration circuit 62. Since both the engine 60 and the processor 52 can request memory or other resources of the high speed bus 50 at the same time, the arbitration circuit 62 arbitrates simultaneous requests for access to the bus 50. The engine 60 also has access to a dedicated high speed cache RAM, such as an SRAM 64. Finally, a bridge circuit 68 is also connected to the high speed bus 50. The bridge circuit 68 is also connected to a slower bus 70, to which a timer 72 is connected, a clock generator 74 is connected, a power management circuit 76 is connected, a security monitoring circuit 78 is connected, a UART 80 is connected, and a SPI circuit 82 (Serial Peripheral Interface—a well known bus) is connected. The UART 80 and the SPI 82 are also connected to a bus 90, which is connected to the NFC 24. The controller 12 is also connected to a bus 91 which is a ISO7816 serial interface bus. It is a byte oriented Universal Asynchronous Receiver/Transmitter (UART) interface commonly found in prior art cell phones between the phone and the SIM card. This type of interface (using UART) is being replaced by the USB interface. Thus, the presence of the bus 91 is for backward compatibility only.

Operation of the Mobile Wireless Communication Device

There are many modes of operation of the mobile wireless communication device 100. Initially, it should be noted that the mobile network operator (MNO), the operator of the cellular network 110, distributes each of the removable cards 10, and also has a server 200 connected to the Internet 150. Each of the removable cards 10 distributed by the MNO is assigned a unique public IP address by the MNO which is stored in the non-volatile memory portion of the removable card 10. The unique public IP address directs the device 100 to the MNO server 200. As disclosed in U.S. patent application Ser. No. 11/637,420, published on Jun. 28, 2007 under publication 2007-0147115, non-volatile memory is present in the NAND memory 20 as well as NOR memory being embedded in the controller 14. In either event, the MNO assigns and pre-stores a unique public IP address in the non-volatile memory portion of the removable card 10. The non-volatile memory may be divided into two portions, with the partition between the first portion and the second portion being alterable. The partitioning of the first portion/second portion can be done by the MNO provider of the removable card 10. The first portion can be accessed by the processor which controls the transceiver 104 and browser and media player 112, and the other hardware circuits that control the communication of the device 100. The second portion can be accessed by the processor 52, in the removable card 10, which is accessible by the user. In addition, the processor 52 controls the degree of access (which includes the type of information) that a user may have to the first portion. In any event, for reasons to be discussed, the unique public IP address assigned by the MNO is stored in the first portion, and the processor 52 prohibits access thereto. However, other types of information, such as sensitive user information, such as user name, credit card, etc. may also be stored in the first portion and the processor 52 may grant the user limited access to those type of information.

After the removable card 10 is distributed to users, and the user has inserted the card 10 into the device 100, the user can then use the device 100 to operate on the cellular network 110, as it was done in the prior art. Similar to the prior art, the card 10 may also have information related to the usage of the device 100, such as telephone number, access code, number of minutes, calling plan etc on the cellular network 110 stored in the first portion (user restricted) of the memory portion of the card 10. Clearly the storage of this type of information in the user restricted is appropriate, so that the user cannot have unlimited access. In this manner, the removable card 10 functions no differently than the SIM card of the prior art when used with the cellular network 110.

When the user attempts to use the device 100 to access the Internet 150, there are at least two possible modes (first mode or second mode) to access the Internet 150. The programming code stored in the non-volatile memory 14 can cause the processor 52 to access the Internet 150 in either the first mode or the second mode of operation.

In the first mode, the Internet 150 can be accessed by the removable card 10 through the USB bus 114 through the device 100 through the cellular network 110. In that event the device 100 is connected to the Internet 150 through the access servers connected to the cellular network 110, near the tower 120. When initiated, the access servers (similar to an Internet Service Provider (ISP)) may assign a dynamic public IP address to the device 100 during the session connecting the device 100 to the Internet 150. Such dynamic assignment of public IP addresses when the device 100 is connected to the Internet 150 is well known in the art and is in accordance with the DHCP protocol. Alternatively, as discussed previously, the public IP address may be pre-assigned and stored in the removable card 10. The browser and media player 112 of the device 100 is then used to browse or surf the Internet 150. Contents from the Internet 150 can then be downloaded and saved in the removable card 10, in either the user restricted memory portion or the user accessible portion of the card 10.

For secure communication with the Internet, the user restricted portion of the memory portion of the card 10 may store a secret key. The RSA/AES/DES engine 60 of the host controller 12 can use that secret key to encrypt and/or decrypt communication to and from the Internet 150. The secret key can be provided by the MNO when it initially distributes the removable card 10 or it can be downloaded from the MNO server 200 which is connected to the Internet 150, when the device is connected to the Internet 150.

The information retrieved from the Internet 150, via the wireless network 110, may be saved in the user restricted portion of the removable card 10 which is associated with an assigned private IP address. The private IP address can be first assigned by the MNO and stored in the removable card 10 before distribution. Alternatively, the private address may be assigned by the access server connected to the cellular network 120. Finally, the private address may simply be the public IP address dynamically assigned by the access severs and then translated by the NAT circuit 106 into a private IP address. After the information from the Internet 150 is stored in the removable card 10, it can be retrieved by the browser and media player 112, again through the USB bus 114, and displayed on the display 108 of the device 100, using the private IP address. This is similar to the operation of an intranet. Thus, the removable card 10 serves to function as a local (private) server in providing the data stored in its memory to the browser and media player 112, all via the USB bus 114.

The use of a “private” IP address when the browser 112 is accessing in a local mode is advantageous because it is more economical than having two public IP address assigned to the device 100: one IP address for the phone portion of the device 100 when surfing or browsing the Internet 150 and another public IP address for the removable card 10, when viewing the contents thereof. Since the content stored in the removable card 10 is for the user using the device 100, there is no need for the removable card 10 to have a public IP address. Furthermore, the time when the user is viewing the contents stored in the removable card 10, the device 100 may not be connected to the Internet 150.

In a second mode, the device 100 can access the Internet 150 other than through the cellular network 110. One way is through a network portal device 170 such as a terminal connected to a PC. In that event, the device 100 or the removable card 10 is connected through the USB bus 114 through the switching device 160 of the present invention to the PC 170. Another way is through a wireless link, such as Wi-Fi which connects wirelessly to a receiving device (not shown) that is connected to the Internet 150. In either way, the device 100 has a switching device 160. Referring to FIG. 5, there is shown schematically a diagram of this mode of communication (along with the first mode) Normally, in the first mode, the removable card 10 is connected to the USB bus 114 through the switching device 160 to the device 100 through its USB interface 113. However, when the device 100 is connected to the PC 170 or through the NFC 24, the switching device 160 is changed causing the removable card 10 to disconnect from the USB interface 113. Thus, for example, when a USB cable is connected to the switching device 160, the switching device causes the removable card 10 to be disconnected from the USB interface 113 of the device 100 and connects the USB bus 114 directly to the PC 170 along its USB port. Because the removable card 10 contains the cellular network 110 access information, if the device 100 was accessing the Internet wirelessly through the cellular network 110, then the device 100 would cease to transmit/receive wirelessly to/from the cellular network 110. Similar to the first mode of operation, when the device 100 is connected to the Internet 150 through the switching device 160, to the PC gateway 170, it is initially assigned a public IP address, by the Internet Service Provider (ISP) for connection to the Internet 150 gain, this is a dynamically assigned public IP address for use during the session that the device 100 is connected to the Internet 150.

Finally, because the removable card 10 stores a public IP address assigned by the MNO, in the user restricted portion of the memory, that public IP address directs the device 100 to the MNO server 200. During the time period when the device 100 is connected to the Internet 150 through the PC portal 170, and when the user is not browsing or surfing the Internet 150, (as in e.g. when the device 100 is connected to the PC gateway 170 through the switching device 160 for charging the battery for the device 100) the device 100 can go the MNO server 200 using the public IP address stored in the removable card 10. The MNO server 200 can then cause content, such as movies, or programming code (updates for the device 100) to be downloaded and stored in the user restricted portion of the removable card 10 of the device 100. The benefit of this mode is that a large amount of content can be downloaded when the device 100 is not connected to the cellular network 110, and when the user is not actively surfing or browsing the Internet 150. The downloaded movies or other material can be subsequently activated by an authorization code and/or payment code. Since the movies or other content were downloaded from the MNO server 200, the user can be sure of the trustworthiness of the content (i.e. free from virus etc.). In addition, since the owner of the content knows that the content is downloaded in a secure manner and stored in a user restricted portion, they can he assured that illicit copies will not be made. In this manner, this becomes a trustworthy procedure for all parties. Finally, by also permitting programming code to be distributed in this manner, an efficient and convenient mode is provided to assure the update of the devices 100.

Furthermore, each removable card 10 may also be assigned a unique IP address by the MNO operator. This offers another feature. When the device 100 with the removable card 10 connected thereto is connected to the Internet 150, and with the removable card 10 having a unique IP address, the MNO server 200 which is also connected to the Internet 150 can download information for all removable cards 10 or just certain removable cards 10 or even only a specific removable card 10. The information downloaded to one or more removable cards 10 may be stored in the user restricted memory portion of the card 10. Examples of information that can be stored in the user restricted portion may include: administrative information such as change in calling plan, increase in minutes etc. Further, the “information” may be data or it may be programming code (including Java applets) for execution by the host controller 12. Thus, for example, the “information” downloaded from the MNO server 200 may be a program causing the host controller 12 to execute the code causing the device 100 to access the cellular network 110 to access the Internet 150 periodically or to access specified location on the Internet 150 (such as the IP address of the MNO server 200) or in some specified manner to retrieve updates, downloads, etc.

Referring to FIG. 6 there is shown a block level diagram of a first embodiment of a switching device 160 of the present invention. The switching device 160 comprises a first two way or full duplex switch 162 having a first output port, designated as “A”, and a second output port designated as “B”. The switch 162 also has an input port 164. The switching device 160 also comprises a second two way or full duplex switch 172 having a first output port, designated as “A”, and a second output port designated as “B”. The switch 172 also has an input port 174. The switching device 160 further comprises a third two way or full duplex switch 182 having a first output port, designated as “A”, and a second output port designated as “B”. The switch 182 also has an input port 184. The second output port “B” of the first switch 162 is electrically connected to the first output port “A” of the second switch 172. The second output port “B” of the second switch 172 is electrically connected to the first output port “A” of the third switch 182. The second output port “B” of the third switch 182 is electrically connected to the first output port “A” of the first switch 162. The input port 164 of the first switch 162 is connected to the removable card 10 The input port 184 of the third switch 182 is connected to the mobile wireless communication device 100, or the cell phone handset. The input port 174 of the second switch 172 is connected to the PC 170. Each of the first, second and third switches, 162, 172, and 182 is switched by a signal GPIO, which is a General Purpose I/O signal, which comprises 2 bits and is transmitted from the wireless device 100 to the first, second and third switches 162, 172, and 182, respectively. Since the GPIO signal is of two bits, four combinations of the signal are possible. In practice, the following states are used: 1) connection between the device 100 and the removable card 10; 2) connection between the device 100 and the PC 170; 3) connection between the removable card 10 and the PC 170; and 4) disconnect state between the device 100, the PC 170 and the removable card 10. The GPIO signals may be generated by the device 100 when the user enters or activates appropriate switches (or buttons”) on the device 100 to indicate the connection desired. The signals supplied to each of the switches 162, 172, and 182 are Data Positive (DP) and Data Negative (DN) all in accordance with the USB standard.

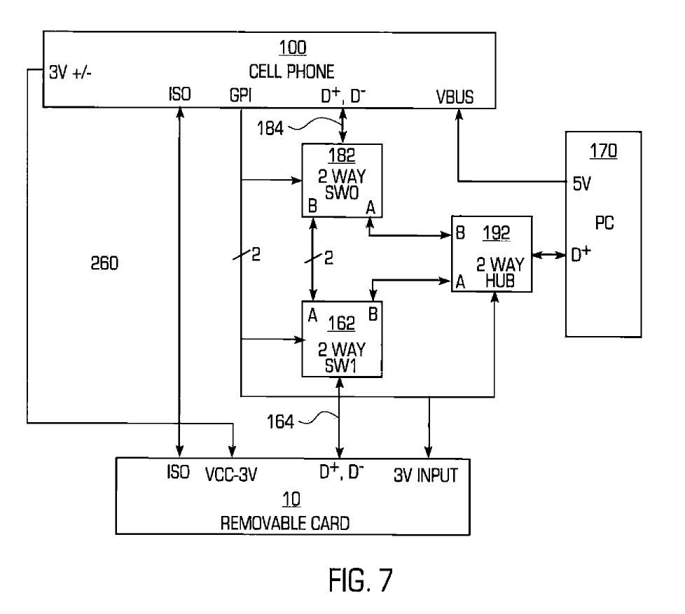

Referring to FIG. 7 there is shown a second embodiment of a switching device 260 of the present invention. The switching device 260 is similar to the switching device 160 shown in FIG. 6. In particular, the switching device 260 comprises a first two way switch 162 having a first output port, designated as “A”, and a second output port designated as “B”. The switch 162 also has an input port 164. The switching device 260 also comprises a third two way switch 182 having a first output port, designated as “A”, and a second output port designated as “B”. The switch 182 also has an input port 184. However, instead of the second switch 172, the switching device 260 comprises a 2 Way Hub 192. The second output port “B” of the first switch 162 is electrically connected to the first output port “A” of the second switch 172. The second output port “B” of the second switch 172 is electrically connected to the first output port “A” of the third switch 182. The second output port “B” of the third switch 182 is electrically connected to the first output port “A” of the first switch 162. The input port 164 of the first switch 162 is connected to the removable card 10 The input port 184 of the third switch 182 is connected to the mobile wireless communication device 100, or the cell phone handset. The input port 174 of the second switch 172 is connected to the PC 170. Each of the first, second and third switches, 162, 172, and 182 is again switched by the signal GPIO, which is generated by the device 100. In the switch 260, however, the hub 192 acts more than a full duplex switch; it can be a host to either the switch 162 or the switch 182. Thus, in the switch 260, the PC 170 can communicate simultaneously with either the device 100 or with the removable card 10. With a hub 192, the PC 170 can communicate directly with the communication device 100 and they can let each other know of the required state change. Thus, control issues become easier. Finally, the ISO signals shown in FIG. 7 are conventional signals (in accordance with the International Standards Organization) to connect and to control a communicating device with a SIM card.

Although the present invention discloses a switching device 160 connecting a mobile wireless device 100 to a computer 170 to a removable card 10, for a two way connection between any of the aforementioned three elements, each of the three elements may also be any device having an interface port that is connectable to the switch 170. Thus, the removable card 10 may be any device with a USB port connecting to a PC 170 or a wireless communicating device 100. Further, the wireless communicating device 100 may be any removable card reader connecting to a PC 170 and to a removable card 10.

What is claimed is:

1. A switching device for selectively connecting a removable card having a first port to a mobile wireless communicating device having a second port or to a computer having a third port, said switching device comprising:
a first full duplex switch having an input and a first output and a second output, and a select port for switching the connection of the input to the first output and the connection of the input to the second output;
a second full duplex switch having an input and a first output and a second output, and a select port for switching the connection of the input to the first output and the connection of the input to the second output;
a third full duplex switch having an input and a first output and a second output, and a select port for switching the connection of the input to the first output and the connection of the input to the second output;
wherein the input of the first full duplex switch is connected to the first port;
wherein the input of the second full duplex switch is connected to the second port;
wherein the input of the third full duplex switch is connected to the third port;
wherein the first output of the first full duplex switch is connected to the second output of the second full duplex switch;
wherein the second output of the first full duplex switch is connected to the first output of the third full duplex switch; and
wherein the first output of the second full duplex switch is connected to the second output of the third full duplex switch.

2. The switching device of claim 1 wherein the input to the first full duplex switch is a USB input.

3. The switching device of claim 2 wherein the input to the second full duplex switch is a USB input.

4. The switching device of claim 3 wherein the input to the third full duplex switch is a USB input.

5. The switching device of claim 1 wherein the select port of the first full duplex switch, the select port of the second full duplex switch, and the select port of the third full duplex switch is activated by one or more signals from the wireless communicating device.

6. A USB switching device for selectively connecting a first USB device having a first USB port to a second USB device having a second USB port or to a third USB device having a third USB port, said switching device comprising:
a first full duplex switch having a USB input and a first output and a second output, and a select port for switching the connection of the input to the first output and the connection of the input to the second output;
a second full duplex switch having a USB input and a first output and a second output, and a select port for switching the connection of the input to the first output and the connection of the input to the second output;
a third full duplex switch having a USB input and a first output and a second output, and a select port for switching the connection of the input to the first output and the connection of the input to the second output;
wherein the USB input of the first full duplex switch is connected to the first port;
wherein the USB input of the second full duplex switch is connected to the second port;
wherein the USB input of the third full duplex switch is connected to the third port;
wherein the first output of the first full duplex switch is connected to the second output of the second full duplex switch;
wherein the second output of the first full duplex switch is connected to the first output of the third full duplex switch; and
wherein the first output of the second full duplex switch is connected to the second output of the third full duplex switch.

7. The switching device of claim 6 wherein the select port of the first full duplex switch, the select port of the second full duplex switch, and the select port of the third full duplex switch is activated by one or more signals from the first USB device.

8. The switching device of claim 6, wherein the first full duplex switch is a USB hub.
